(19) United States
(12) Patent Application Publication
(10) Pub. No.: US 2008/0166118 A1
(43) Pub. Date: Jul. 10, 2008

(54) Network camera holder

(76) Inventor: Hui-Hu Liang, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/651,474

(22) Filed: Jan. 10, 2007

(51) Int. Cl. G03B 17/00; H04N 5/225

(52) U.S. Cl. 396/428; 348/373

(57) ABSTRACT

An improved construction of a network camera holder includes an L-shaped holder comprised of a vertical plate and a horizontal plate; a hollowed chamber disposed to the vertical plate extending to the horizontal plate through a transition area of the L-shaped holder; a network camera being pivoted to the transition area and inserted into the hollowed chamber for the horizontal plate of the L-shaped holder to be placed on a flat surface with the camera in the hollowed chamber to face its target; or the camera being turned over to erect by operating a pivot provided in the transition area to clear off the hollowed chamber with both distal ends resting on a flat surface for the camera to face its target; or the transition area of the L-shaped holder striding over an upper edge of a monitor for the erected to camera to fact its target to facilitate interchanging the position of the erected camera to face its target.

### BACKGROUND OF THE INVENTION

(a) Field of the Invention

The present invention is related to a network camera holder, and more particularly, to an erected L-shaped holder including a vertical plate containing a hollowed chamber that extends through a transition area to a horizontal plate containing a hollowed slot; a network camera being pivoted to the transition area to be inserted into the hollowed slot or to turned over into erected position for the network camera to be either placed on a flat surface or to striding over a monitor.

(b) Description of the Prior Art

Whereas a network camera generally available in the market is either placed on desktop or hooked upon a monitor, both positions are not interchangeable to limit the operation of the camera by its user. Even the prior art allows the camera to be secured in both positions as desired, the construction and erection of its holder are comparatively complicated and involve higher cost, and even more complicated in case of a construction that allows adjustable angle. Therefore, various designs are available to provide the interchangeable function for the user to place the network camera as desired.

### SUMMARY OF THE INVENTION

The primary purpose of the present invention is to provide an improved construction of a network camera holder to solve the problems of limited use as found with the prior art by allowing multiple choices of a desired location to place the camera. To achieve the purpose, the present invention is related to an L-shaped holder comprised of a vertical plate and a horizontal plate. The vertical plate contains a hollowed chamber that extends to the horizontal plate through a transition area. A network camera is pivoted to the transition area. With the network camera inserted into the hollowed chamber, the horizontal plate of the L-shaped holder is placed on a flat surface while the network camera in the hollowed chamber faces toward its target; or the network camera when pivoted to the transition area may be turned over into erected status by clearing out of the hollowed chamber for both ends of the vertical plate and the horizontal plate to be placed on a flat surface with the network camera facing its target; or the transition area of the L-shaped holder strides over an upper edge of a monitor for the erected network camera to face its target.

For achieving attractive appearance purpose, the hollowed chamber disposed to the vertical plate of the L-shaped holder of the present invention may be made in a shape corresponding to that designed for the network camera.

The network camera is pivoted to a hollowed slot disposed in the transition area of the L-shaped holder, and the hollowed slot is inserted to two pivoting holes respectively provided on both sides of the hollowed slot by means of a pivot for the camera to turn over.

### BRIEF DESCRIPTION OF THE DRAWINGS

FIG. 1 is a perspective view of a first preferred embodiment of the present invention as assembled.

FIG. 2 is a perspective view of a second preferred embodiment of the present invention.

FIG. 3 is a schematic view showing an overturn movement executed by a network camera of the present invention.

FIG. 4 is a perspective view showing a third preferred embodiment of the present invention.

FIG. 5 is a perspective view showing a fourth preferred embodiment of the present invention.

### DETAILED DESCRIPTION OF THE PREFERRED EMBODIMENTS

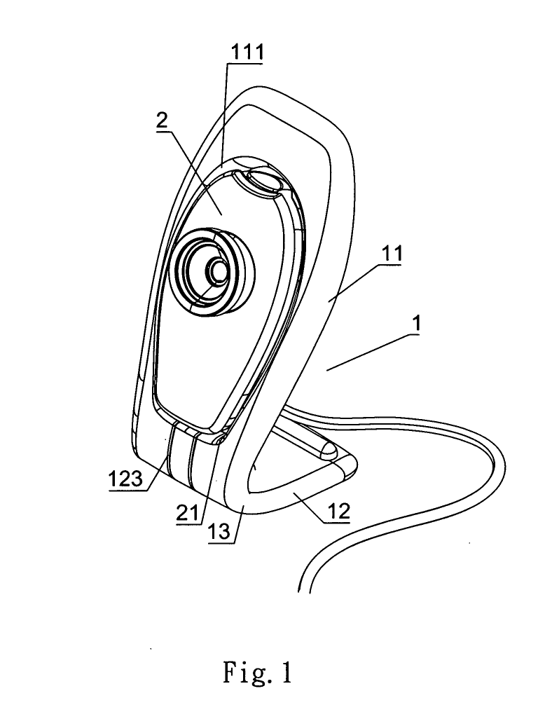

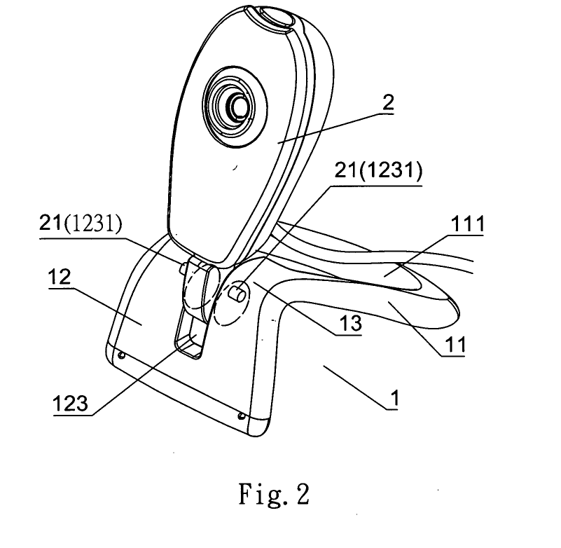

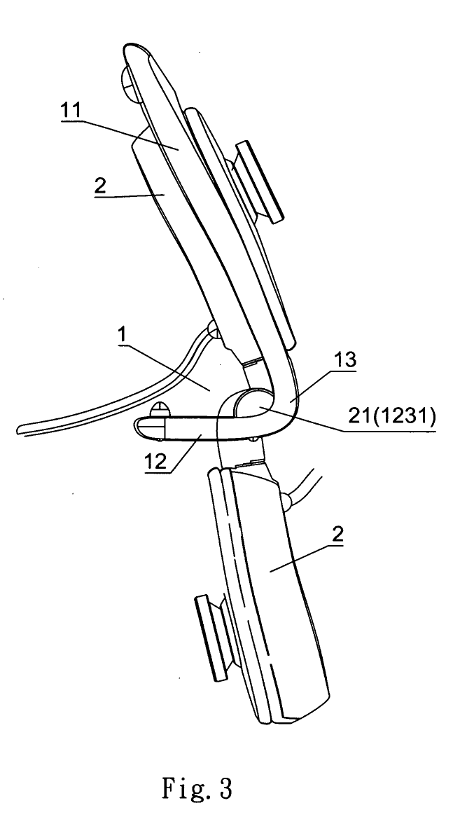

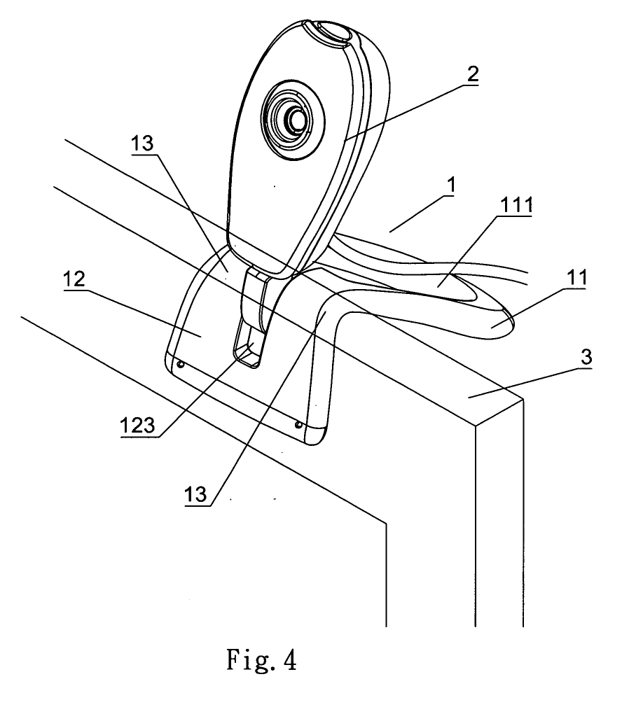

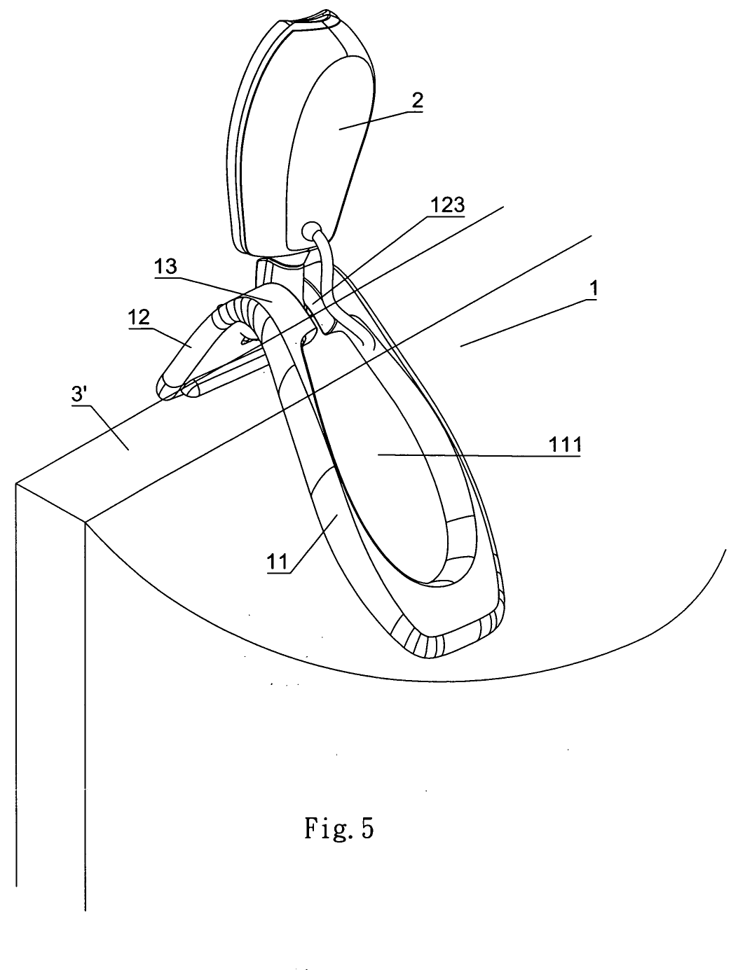

Referring to FIGS. 1 and 2, a first preferred embodiment of the present invention includes an L-shaped holder 1 comprised of a vertical plate 11 and a horizontal plate 12. A hollowed chamber 111 disposed to the vertical plate 11 extends to define a hollowed slot 123 in the horizontal plate 12 through a transition area 13 of the L-shaped holder 1. A network camera 2 is pivoted to the transitional area 13. To achieve the purpose of providing multiple choices to place the network camera 2, the hollowed chamber 111 is provided to receive the insertion of the network camera 2 when the horizontal plate 12 of the L-shaped holder 1 is placed on a flat surface with the network camera 2 disposed in the hollowed chamber 111 to face a target as illustrated in FIG. 1. Alternatively, the network camera 2 is turned over in the transition area 13 by operating a pivot 21 to clear away from the hollowed chamber 111 and put in an erected status as illustrated in FIG. 3, and both distal ends in relation to the transition area 13 respectively of the vertical plate 11 and the horizontal plate 12 rest on a flat surface to achieve the similar purpose of having the network camera 2 to face its target as illustrated in FIG. 2. Furthermore, the transitional area 13 of the L-shaped holder may be put to stride over an upper edge of a monitor 3, e.g., a LCD 3 as illustrated in FIG. 4 or a cathode-ray tube display 3′ as illustrated in FIG. 5 to have the erected network camera 2 facing its target.

As illustrated in FIGS. 1, 2, and 3, the network camera 2 is pivoted to the hollowed slot 123 in the transitional area 13 of the L-shaped holder to allow the network camera 2 to be turned over by inserting the pivot 21 through two pivoting holes 1231 respectively disposed on both sides of the hollowed slot 123 of the transition area 13.

Now referring to FIG. 1, the hollowed chamber 111 disposed to the vertical plate 11 of the L-shaped holder 1 may be made in a shape by compromising that designed for the network camera for demonstrating attractive appearance for the network camera 2 and the L-shaped holder 1 as a whole.

What is claimed is:

1. An improved construction of a network camera holder includes an L-shaped holder comprised of a vertical plate and a horizontal plate; a hollowed chamber being disposed to the vertical plate, the hollow chamber extending through a transition area of the L-shaped holder to define a hollowed slot in the horizontal plate; the transition area being provided for a network camera to be pivoted to; the network camera being pivoted in the transitional area of the L-shaped holder and inserted and secured in position in the hollowed chamber; and the network camera being placed on a flat surface by turning over at its pivoted position in the transition area to clear away from the hollowed chamber or striding over a monitor by being inserted and secured in position in the hollowed chamber to facilitate interchanging its location.

2. The network camera holder as claimed in claim 1, wherein the network camera is pivoted to the hollowed slot in the transition area of the L-shaped holder; and a pivot is inserted through two pivoting holes respectively disposed on the inner side of the hollowed slot in the transition area for the network camera to turn over.

3. The network camera holder as claimed in claim 1, wherein the L-shaped holder is placed on a flat surface and the network camera is positioned in the hollowed chamber to face its target.

4. The network camera holder as claimed in claim 1, wherein the network camera turns over to clear away from the hollowed chamber to indicate an erected status; and both distal ends in relation to the transition area respectively of the vertical plate and the horizontal plate rest on a flat surface for the network camera to face its target.

5. The network camera holder as claimed in claim 1, wherein the transition area of the L-shaped holder strides over an upper edge of a monitor for the erected network camera to face its target.

6. The network camera holder as claimed in claim 1, wherein the shape of the hollowed chamber disposed to the vertical plate may be designed in corresponding to that designed for the network camera for achieving overall attractive appearance.
